(19) United States
(12) Patent Application Publication
(10) Pub. No.: US 2007/0156648 A1
(43) Pub. Date: Jul. 5, 2007

(54) System and method for providing searchable help on a multi-function peripheral

(76) Inventors: Amanda Kay Bridges, Winchester, KY (US); William James Gardner Flowers, Lexington, KY (US); Charles Grieshaber, Versailles, KY (US); Benjamin Seth Moore, Georgetown, KY (US)

Correspondence Address: LEXMARK INTERNATIONAL, INC.;INTELLECTUAL PROPERTY LAW DEPARTMENT, 740 WEST NEW CIRCLE ROAD, BLDG. 082-1, LEXINGTON, KY, 40550-0999, US

(21) Appl. No.: 11/317,609

(22) Filed: Dec. 23, 2005

(51) Int. Cl. G06F 17/30

(52) U.S. Cl. 707/3

(57) ABSTRACT

A searchable help system for a multi-function peripheral (MFP) adapted for receiving one or more search keywords from any display screen of a man-machine interface is provided. Upon receipt of one or more keywords, the help system searches all help content files for all matches. The search results are displayed to the user by section topic or header and the associated help content file, wherein each result indicates that the corresponding textual help contend contains one more of the search key words.

### BACKGROUND OF THE INVENTION

1. Technical Field

The present invention relates to man-machine interfaces used in the control and operation of multi-functional peripherals, and in particular, to a man-machine interface for a multi-functional peripheral having a searchable help system available at any level of user control screens.

2. Related Art

Multi-functional peripherals (MFPs) are becoming increasingly complex with respect to the number of different control functions available. For example, a multi-function peripheral may offer printing, copying, faxing, e-mailing, and scanning functions of one or more documents. In order to activate a given function, a user must access a man-machine interface which typically consists of a graphical interface having multiple soft buttons on a touch screen display organized in multiple menu layers. A user pushes a series of soft buttons on the various display screens to navigate through the menu layers to find and activate the desired function.

Due to the increasing number and variety of functions available on a MFP, it is often very difficult for a user to keep track of or even know all of the appropriate buttons for finding and activating a particular function. As a result, a user often accesses the help function of the menu interface to locate information on the operation and activation of a particular function. However, a user may be frustrated by conventional help systems of an MFP in that they are not flexible and presuppose the needs of the user. Therefore, a more flexible help system for an MFP is needed.

Contextual help available to a user via the display screens has traditionally been a weak area in MFP functionality. Although almost all conventional MFPs provide some version of help, there are often large “holes” in the help system wherein a typical display screen informs a user that “There is no Help available for that item.” This problem arises from the fact that MFPs have a large number of command functions, and each such command function requires a corresponding help content file or portion thereof. In order to have a useful help system, the help content file(s) should match the command function software and the operation of the various commands from the display screens. As a result, there may be a maintenance problem in keeping the help content files up-to-date with the software development efforts for each command function.

Certain MFPs, such as the X820c and associated lines of Lexmark MFPs, use one or more HTML files, rendered by a Java pseudo-browser, to institute a linked and indexed set of pages of help information. Each page is one display screen in size and contains help content for a specific MFP control display screen along with one or more links to other help content screens. This page provides the means for connecting multiple help screens. Thus, as a user enters the help system, the user may navigate through multiple levels of help content for a given control display screen.

The problem with using such indexes or other forms of static links for connecting help screens is that the subject on which help is sought may not be immediately obvious in the initial help content screen. Thus, a user must navigate the help system according to the predefined and static links of the help screens. This process may be very frustrating to a user, and studies have shown that a user is reluctant to spend much time navigating a help menu to locate the desired help content.

Therefore, there is a need for a flexible help system on a MFP that allows a user the ability to search the available help content files for a specific topic and not be limited by a predefined list of help topics or static links connecting various help screens. There also is a need for a MFP help system in which a user inputs one or more search keywords that are used as a basis for searching the help content files for one or more matches. There is a further need that such a navigation method of help content files is text searching with alphanumeric character entry.

In reviewing several commercially available MFPs, including CopyCentre C20 by Xerox, MFP model nos. MFC-210C and 420CN by Brother, MFP model no. CMYK Plus by Hewlett-Packard, and Stylus Scan 2000 by Epson, it was found that each of these systems provides a user with a static set of pre-defined help topics. A user selects a help topic, after which, the system displays information on the selected topic. Thus, these prior art products disclose MFPs having a static help system of predefined help topics. These prior art products do not disclose a MFP having a flexible and searchable help system wherein a user may access all help content files from any menu level of user control screens.

The disadvantage with conventional help systems on a MFP is that they are limited to providing the user with a pre-defined set of help topics based on the specific menu level of the user. That is, as a user selects the help button, the help system either provides a list of pre-defined help topics that correspond to the user's current menu display or provides informational text on the current menu display. The user does not have the ability to search all help topics. Therefore, if a user inadvertently pushed the control buttons such that he/she is on the wrong menu display, the user's activation of the help system is not helpful but rather may be frustrating to the user because the displayed help screens are directed to the current menu level and not to those menu screens where the user wants to be. Therefore, there is a need for a flexible help system for a MFP that allows a user the ability to search all help topics and content files from any menu level.

In U.S. Pat. No. 6,198,939 to Holmström, et al., a man-machine interface help and search tool and method is disclosed for providing searchable help information on a mobile phone. In particular, a user may enter “search mode” from any screen or from any menu level of the mobile phone. When in search mode, the user enters one or more keywords for searching the help information. The system then searches its table of available mobile commands looking for a match or the closest match between the entered search term by the user and the available mobile commands. Once identified, the selected help information for the entered command is displayed to the user. The user then has the option of executing the command associated with the user entered search term.

The disadvantage of the '939 patent is that it is limited to mobile phones and the specific mobile commands available. The '939 patent does not have a help system that searches the available help content files by the user entered search terms. Further, the '939 patent is a system wherein only the command names are searched by the entered search terms. Thus, unless the user knows the exact name or abbreviation of the desired command, or a close spelling of such command, the user will not be able to retrieve the help information on the desired command. Therefore, there is a need for a flexible searchable help system for an MFP wherein all help content files, and not just the command names, are searched according to the user's search terms.

In U.S. Pat. No. 6,690,390 to Walters et al., a computer system and method is disclosed for performing an executable task from within an interactive, on-line help information display. A user selects a help topic from a list of available such topics, each of which is associated with performing a function. Upon selection by the user, the resulting on-line help information is displayed to the user wherein the user may then select to execute the associated function. Thus, the '390 patent discloses a help system wherein a user may only make a selection from a list of pre-defined help topics. The user may not enter arbitrary keywords for searching the on-line help information. Therefore, there is a need for a searchable help system for a MFP wherein a user may enter one or more key search words for searching the all of the help content files, and the search not being limited to searching only help topic headers.

In U.S. Pat. No. 6,862,713 to Kraft, et al., a method is disclosed for searching the indexed list of a set of documents according to a plurality of keywords entered by a user wherein the search results are presented to the user after the entry of each keyword. A user is presented with intermediate search results as the keywords are entered. In addition, the search performed by the '713 patent only searches the available index. The search does not open and review the corresponding content files. Thus, the '713 patent discloses a continuous type of searchable help system providing a user with a constant narrowing of search results of an index as search keywords are entered. The disadvantage with the '713 patent, is that it discloses a help system that does not provide a user with the ability to search the entire help content files, but rather is limited to searching only an index for such help content files.

Therefore, there is a need for a searchable help system for a MFP wherein a user may enter one or more keywords from any menu level of the control panel. There is a further need for a searchable help system for a MFP wherein the requested search is performed on all of the available help content files and is not limited to only searching an index of help topic.

### SUMMARY OF THE INVENTION

The present invention solves the problems associated with traditional help systems of multi-functional peripherals (MFPs) by providing searchable help capabilities from any display screen of the MFP's man-machine interface. The searchable help system of the present invention is a system and method for enabling a user to have searchable help capabilities at any level of menu display screens used in conjunction with MFPs. That is, regardless of which level of display screen a user is accessing on the MFP's control panel, the user has the option of entering one or more keywords for searching help information. With the present invention, an MFP user may customize a help request from any menu screen by entering his/her own search criteria. Upon receipt of the search key words, the help system searches each help content file associated with the man-machine interface and the command functions of the MFP for one or more matches. All search results, or portions of the help content files that satisfy the search criteria, are displayed to the user by their section or topic header and the corresponding help content file wherein each result indicates that the corresponding textual help content contains one more of the search key words. The user then has the option of returning to the menu display screens or reviewing additional help information.

There are many advantages with the help system of the present invention. First, an MFP user is no longer subject to being presented with a static set of predefined help topics for a given menu level wherein such set of help topics is pre-loaded by the vendor. The user may enter the one or more keywords that best describes the function that the user desires to execute.

Second, conventional help systems associated with operating an MFP provide searchable help capabilities that only search an index of help topics. In contrast, the present help system searches all of the available help content files. Therefore, a search goes beyond the index of topics, thereby providing a user with greater search capabilities and the ability of finding help text not otherwise locatable.

Third, the conventional help systems for an MFP are preset and locked into a specific hierarchy of help menus. Thus, if a user does not find the exact help information needed, the user must navigate through the hierarchy of help menus searching arbitrarily for the desired topic. This process may be very time consuming and frustrating for the user. In contrast, the searchable help system of the present invention allows a user to directly search all help files, thereby when appropriate eliminating the hierarchy of help menus.

### BRIEF DESCRIPTION OF THE DRAWINGS

The present invention is described with reference to the accompanying drawings. In the drawings, like reference numbers indicate identical or functionally similar elements. Additionally, the left-most digit(s) of a reference number identifies the drawings in which the reference number first appears.

FIG. 1 is an exemplary flow diagram of a top-level help function according to the present invention;

FIG. 2 is an exemplary flow diagram of a forward arrow function according to the present invention;

FIG. 3 is an exemplary flow diagram of a backward arrow function according to the present invention;

FIG. 4 is an exemplary flow diagram of a help search function according to the present invention;

FIG. 5 is an exemplary flow diagram of an index function according to the present invention;

FIG. 6 is an exemplary flow diagram of a help topic display function according to the present invention;

FIG. 7 is a block diagram of an exemplary MFP display window showing the top-level menu screen according to the present invention;

FIG. 8 is a block diagram of an exemplary MFP display window showing a specific function according to the present invention;

FIG. 9 is a block diagram of an exemplary MFP display window showing a top-level help screen according to the present invention;

FIG. 10 is a block diagram of an exemplary MFP display window showing a help keyboard screen according to the present invention; and

FIG. 11 is a block diagram of an exemplary MFP display window.

### DETAILED DESCRIPTION

The present invention is a multi-function peripheral (MFP) having a man-machine interface for controlling the operation of the MFP. The man-machine interface may be a series of display screens organized in a hierarchical structure corresponding to the hierarchical structure of the command functions for operating the MFP. Therefore, in operation, a user accesses the display screens to select command functions, such as copy, fax, or scan, corresponding to the desired action. Subsequent display screens may then be used as a means for displaying information on the status of a selected command function.

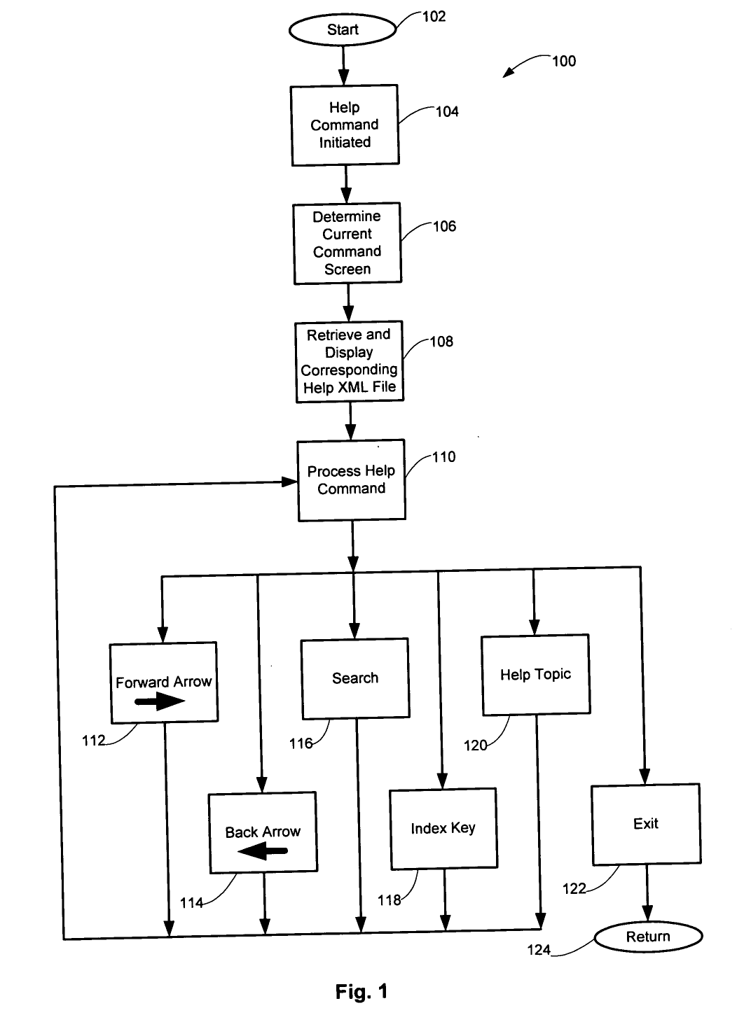

The present invention incorporates a searchable help system into the man-machine interface and display screens of an MFP, wherein the searchable help system provides a means for searching all available help content files from any level of display screen. FIGS. 1-6 are exemplary flow diagrams of the operation of the searchable help system 100, and FIGS. 7-11 are exemplary display windows for a MFP man-machine interface of the present invention.

FIG. 1 shows the top-level operation of the searchable help system 100 (or help function 100) according to the present invention. The help function 100 is available from every display screen of an MFP. For example, FIG. 7 shows the top level menu display screen for operating an MFP, wherein a display window 702 displays the various functional commands for controlling and operating the MFP. In this example, the following command functions (or commands) 704 are offered: fax 704a, copy 704b, and e-mail 704c, wherein each such command 704 is selected or activated by touching the corresponding soft button. The MFP of the present invention is described in terms of these commands 704 for convenience purposes only. It would be readily apparent to one of ordinary skill in the art to employ the help function 100 of the present invention with an MFP having alternative command 704, such as, scan.

In addition to the basic functionality of the MFP, the display window 702 contains a control bar 706 containing soft buttons and/or informational boxes. Specifically, the control bar 702 contains a help soft button 708, a status type box 710, a status box 712, and a menu soft button 714. In an exemplary embodiment, the location of the help soft button 708 is consistent across all of the display screens. Also, the description of the contents of the control bar 702 other than the help soft button 708 is for convenience purpose only.

Also in the exemplary embodiment, each help soft button 708 of the help system 100 may be linked to a specific help content file and a specific location in that content file. Thus, the help system 100 of the present invention may have one or more help content files, each of which has one or more sections of help content wherein each section contains either an index showing what commands 704 are available on the corresponding display screen or, if the corresponding display screen contains a single command function 704, showing textual information about that specific command 704. The help content files of the present invention are preferably in the XML file format. However, the help content files may be in any other human readable format, such as .HTML, .PDF or .TXT.

Operationally, upon touching the help soft button 708, processing of the help system 100 begins at block 102 and immediately proceeds to block 104. In block 104, the help system 100 initiates the help command and continues to block 106 wherein the help system 100 determines the current command screen being displayed to the user. Processing continues to block 108 in which the help system 100 traverses the link from the specific help soft button 708 to the corresponding section of a help content file and displays the portion of the help content file on a help display screen. Once the help content file is displayed, processing proceeds to block 110 wherein the help system 100 processes the user's selected commands on the help display screen. That is, in the exemplary embodiment, the following commands are available, each of which is described in detail below: forward arrow 112, back arrow 114, search 116, index key 118, help topic 120, and exit 122.

As noted above, the help content displayed to the user may be an index of commands 704 or textual content. For example, upon activating the help soft button 708 on FIG. 7, the help system 100 displays help content for the highest level index, including help indices for each of the displayed commands 704a-c. The user may then select an entry from the index for help content on the selected index entry.

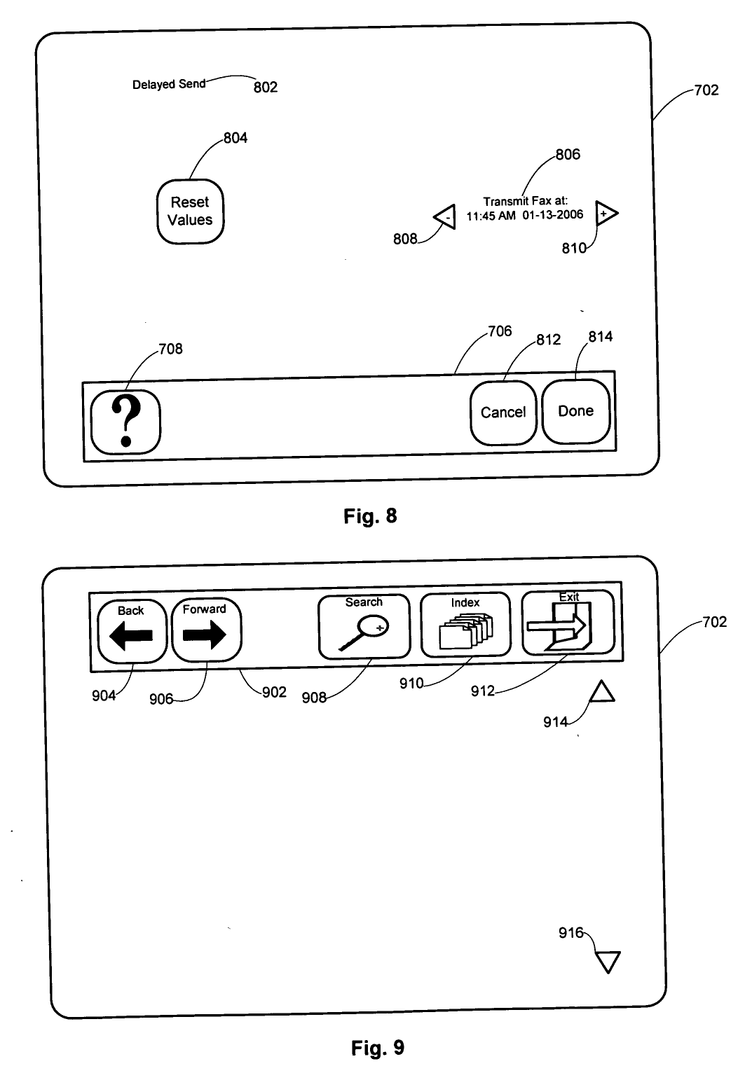

Referring to FIG. 8, display window 702 shows the Delayed Send command 802. The display window 702 shows the various elements associated with the Delayed Send command 802, such as a reset values soft button 804, a date and time indicator 806 for controlling when the fax is to be transmitted, and a down arrow 808 and an up arrow 810 for adjusting the date and time indicator 806. The control bar 706 for this command provides the help soft button 708, along with a cancel soft button 812 and a done soft button 814. Operationally, upon activation of the help soft button 708, the help system 100 displays textual help content solely about the Delayed Send command 802.

Regardless of whether the help content is an index of commands or textual content, the display window 702 containing such help content is shown in FIG. 9. For convenience purposes only, no actual content is shown in the body of the display window 702. A help control bar 902 is displayed across the top of the display window 702 and contains a back soft button 904 (described in block 114), a forward soft button 906 (described in block 112), a search soft button 908 (described in block 116), an index soft button 910 (described in block 118), an exit soft button 912 (described in block 122), an up soft button 914, and a down soft button 916.

The back soft button 904, forward soft button 906, up soft button 914, and down soft button 916 are used to navigate the help content displayed on the display window 702. That is, the up soft button 914 is active when there is additional help content to be displayed that is located above the visible top line of the help content in the display window 702. Upon activating the up soft button 914, the help system 100 automatically rewrites the previous section or page of help content in the display window 702. The down soft button 916 is active when there is additional help content to be displayed that is located below the visible bottom line of the help content in the display window 702. Upon activating the down soft button 916, the help system 100 automatically rewrites the next section or page of help content in the display window 702.

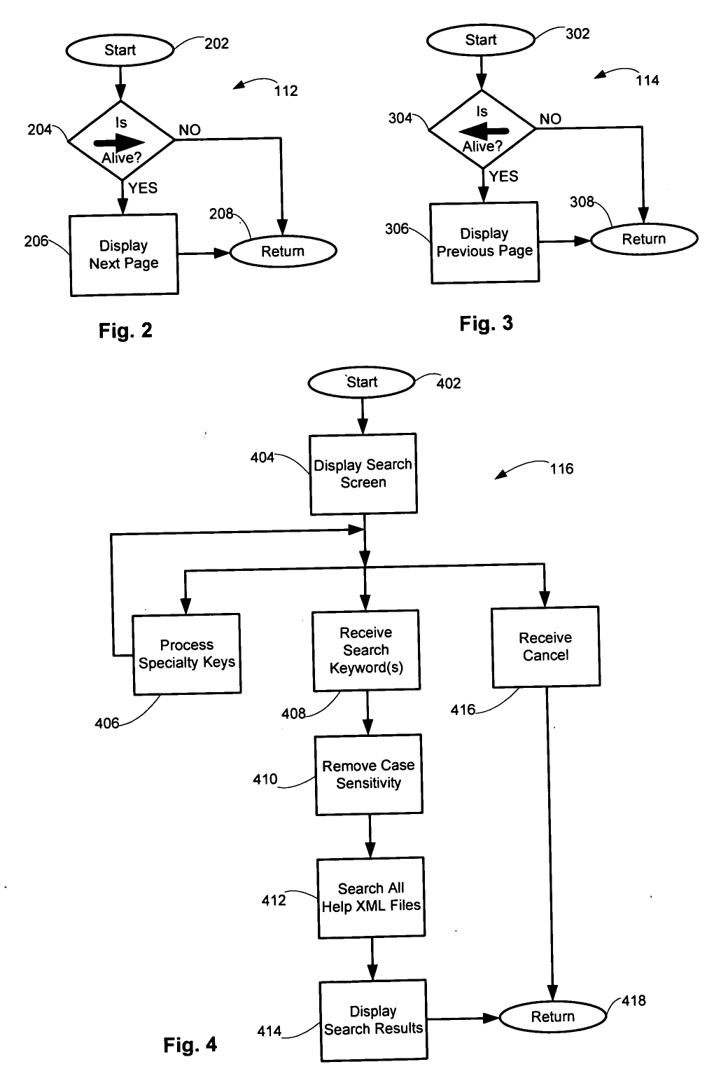

Likewise, the back soft button 904 and the forward soft button 906 operate according to conventional methods. Referring to FIG. 2, processing 112 for the forward soft button 906 begins at block 202 when a user touches the forward soft button 906 and proceeds to block 204. Block 204 determines whether the forward soft button 906 is active, and if it is, processing continues to block 206, where the help system 100 displays the next page on display window 702. Processing then continues to block 208 and returns. If block 204 determines that the forward soft button 906 is not active, processing continues to block 208 and returns.

Referring to FIG. 3, processing 114 for the back soft button 904 begins at block 302 when a user touches the back soft button 904 and proceeds to block 304. Block 304 determines whether the back soft button 904 is active, and if it is, processing continues to block 306 wherein the help system 100 displays the previous page on display window 702. Processing then continues to block 308 and returns. If block 304 determines that the back soft button 904 is not active, processing continues to block 308 and returns the user to the display screen from which help was entered.

Referring again to the help control bar 902, the activation of the exit soft button 912 returns the user to the display screen 702 from which the help system 100 was entered. In addition, as an alternative to the user touching the exit soft button 912, the help system 100 has a screen timeout such that after a lapsed pre-defined time period without any user input, the help system 100 automatically activates the exit soft button 912. In the exemplary embodiment, the automatic screen timeout is a time period that is long enough to allow a user to read any help content, such as about five minutes.

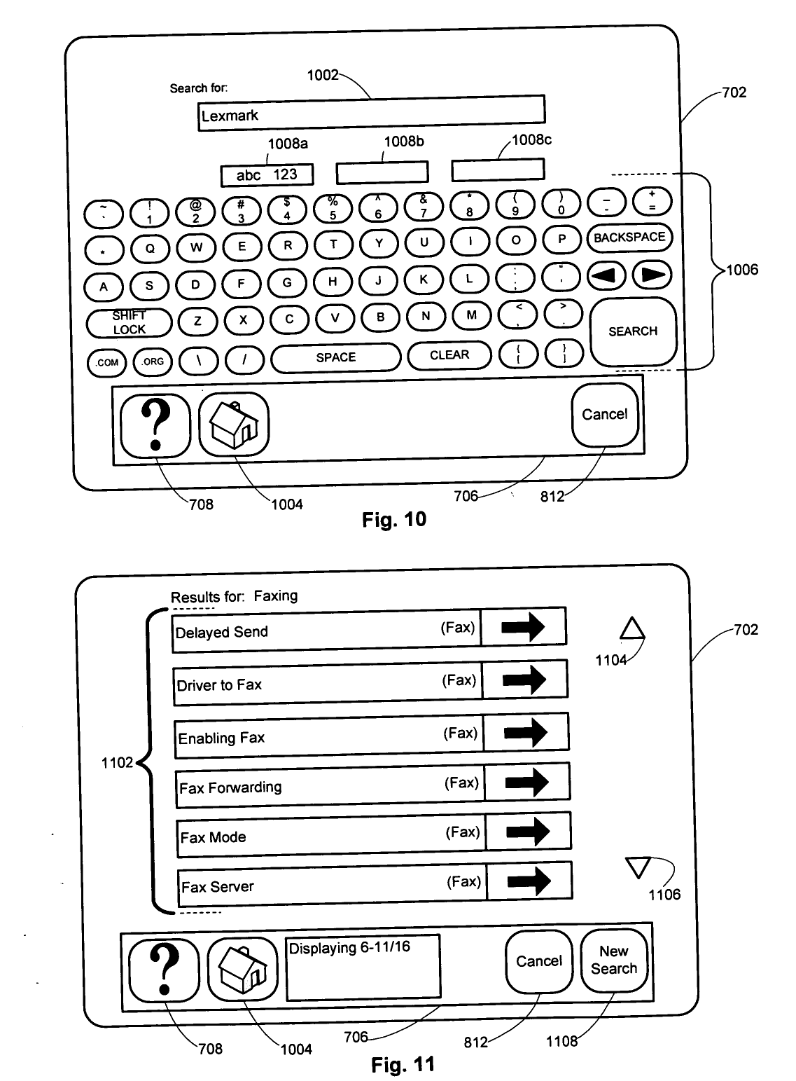

FIG. 4 is the operational flow diagram showing the functionality of the search soft button 908. Upon activating the search soft button 908 in a help content display screen, the help system 100 starts processing at block 402 and immediately proceeds to block 404. At block 404, the help system 100 displays a search screen, an example of which is shown in FIG. 10. The exemplary search screen contains a search box 1002 for receiving one or more search key words, a virtual key board comprised of a plurality of alphanumeric soft keys 1006, and a control bar 706. The virtual keyboard is shown having the alphanumeric soft keys 1006 arranged as a conventional keyboard, but this is for convenience. The control bar 706 has a help soft key 708, a home soft key 1004 for taking a user back to the initial help display screen, and a cancel soft key 812 for canceling the current operation.

Once the search screen is displayed, the user has the option of selecting a specialty key, such as the top keys 1008a-c, entering one or more search keywords, or canceling the operation. Upon selection of a specialty key 1008a-c, the help system 100 continues to block 406 to process the selected specialty key 1008a-c. Processing then returns to the screen from which help was entered and waits for the user's next selection.

Upon selection of one or more alphanumeric keys from the virtual keyboard 1006, the letters and numbers corresponding to the user's selections appear in the search box 1002. When the search keywords are entered and the Search soft key is selected, processing continues to block 408, wherein the one or more search keywords are received. Continuing to block 410, the help system 100 removes all case sensitivity by translating the search keywords to either all upper or all lower case letters. The help system 100 then uses the search keywords and searches all of the help content files for one or more matches. That is, the entire help content files are searched, and the search is not limited to only the section or topic headers. All matching results are then displayed in a display window such as that shown in FIG. 11.

Referring to FIG. 11, the search results are returned in a preferred format with the one or more search keywords shown in the top left of the display window 702. In this example, the shown search keyword is “faxing.” The actual results are displayed in one or more rows 1102, each row indicating the help content file and the section topic header within that help content file for which a match was found. Specifically, the left side of each row 1102 is the section topic header of the shown help content file listed at the right side. Also in the exemplary embodiment, a specific combination of section topic header and help content file is displayed in the list of search results regardless of the number of “hits” or “matches” found within that corresponding section of the help content file. An up arrow soft button 1104 and a down arrow soft button 1106 provide the means for scrolling through the list of search results. Also, a new search soft button 1108 allows a user to return to the search screen of FIG. 10 to enter one or more different search keywords. After the search results are displayed, or when the user presses the cancel soft button 416, processing continues to block 418 and returns to the display screen from where help was selected or entered.

When provided a list of search results, the user may select, or touch, one of the rows (help topics) for a display of the corresponding textual help content. Processing is performed in block 120 which is described in detail in FIG. 6. After activating a help topic, processing proceeds from block 602 to block 604. At block 604, the help system 100 displays the portion of the help content (XML) file that corresponds to the selected help topic. The display may appear in the exemplary display window format shown in FIG. 9. Once the help content is displayed, processing continues to block 606 and returns to the display screen from where help was selected or entered.

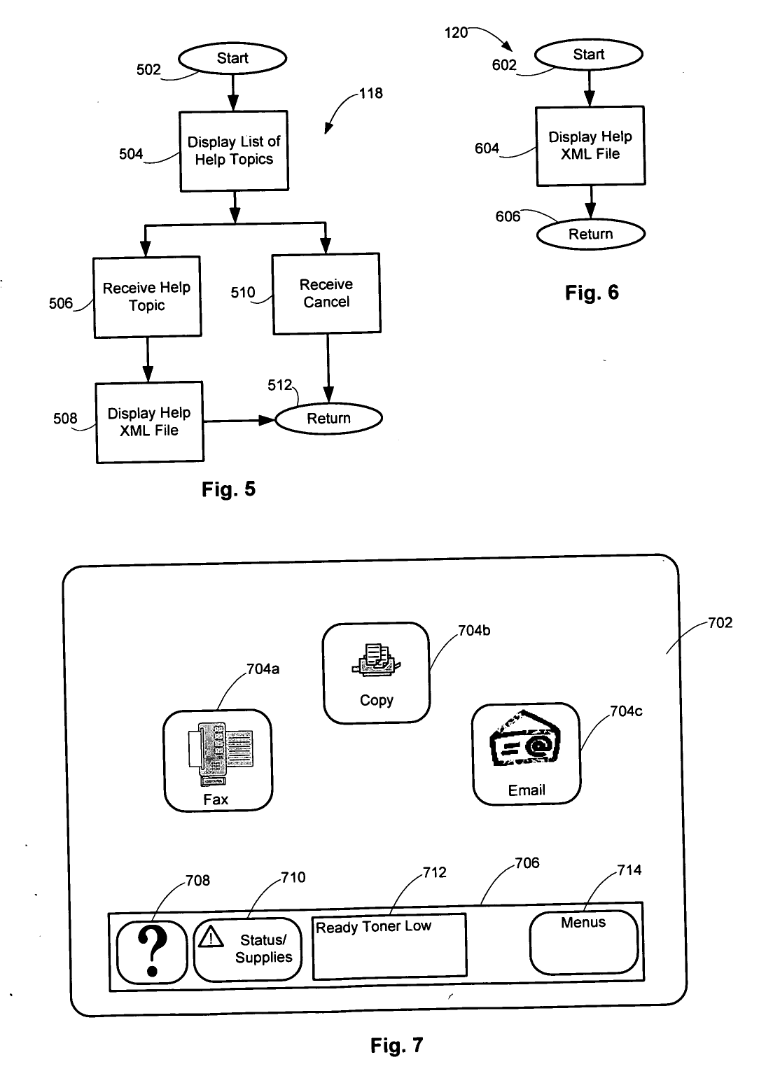

Referring again to FIG. 9, a user may select the index soft button 910, which is described in block 118 and FIG. 5. Upon activation of the index soft button 910, processing proceeds from block 502 to block 504. At block 504, the help system 100 displays a list of help topic or indices from the help content files corresponding to the user's current display window 702. The user may either select a help topic or cancel the command. If the user selects one of the help topics displayed, processing continues to block 506 wherein the help system 100 receives the selected help topic. Then, continuing to block 508, the textual help content is displayed to the user in a manner similar to block 604 described above. Once the help content is displayed, processing continues to block 512 and returns to the screen from where help was entered. Alternatively, if the user decides to cancel the operation, processing proceeds from block 510 to block 512 and returns.

While various embodiments of the present invention have been described above, it should be understood that they have been presented by the way of example only, and not limitation. It will be understood by those skilled in the art that various changes in form and details may be made therein without departing from the spirit and scope of the invention as defined. Thus, the breadth and scope of the present invention should not be limited by any of the above-described exemplary embodiments.

What is claimed is:

1. A multi-function peripheral device, comprising:
a means for printing a document;
a means for scanning a document; and
a man-machine interface, comprising:
a plurality of display screens for controlling an operation of the multi-function peripheral, said plurality of display screens organized in an hierarchical structure corresponding to an hierarchical structure of command functions for the multi-function peripheral device;
a means for displaying on said plurality of display screens said command functions for controlling the multi-function peripheral;
a means for receiving from said plurality of display screens a selected command function from a user; and
a searchable help system available on each of said plurality of display screens, said searchable help system having one or more help content files, each said help content file having one or more sections, each said section having textual help content, said searchable help system adapted for receiving one or more search keywords, searching said one or more help content files for said one or more search keywords, and displaying on at least one said display screen one or more help topics with a corresponding said help content file, wherein said textual help content corresponding to said one or more help topics being displayed contains one or more of said search keywords.

2. The multi-function peripheral device according to claim 1, wherein said one or more help content files contain detailed help information on the control and operation of the multi-function peripheral and on said command functions.

3. The multi-function peripheral device according to claim 1, wherein said one or more help content files are in XML file format.

4. The multi-function peripheral device according to claim 1, wherein said searchable help system has a virtual keyboard for receiving said one or more search keywords.

5. A method for searching and displaying help information for a multi-function peripheral device, comprising:
placing a multi-function peripheral device in search mode, said multi-function peripheral device comprising:
a means for printing a document,
a means for scanning a document, and
a man-machine interface, said man-machine interface comprising:
a plurality of display screens for controlling an operation of the multi-function peripheral, said plurality of display screens organized in an hierarchical structure corresponding to an hierarchical structure of command functions for the multi-function peripheral device;
a means for displaying on said plurality of display screens said command functions for controlling the multi-function peripheral;
a means for receiving from said plurality of display screens a selected command function from a user; a means for displaying information on a status of said selected command function; and
a searchable help system available on each of said plurality of display screens;
receiving one or more search keywords associated with a desired command function;
searching with said one or more search keywords one or more help content files, each said help content file having one or more sections, each said section having textual help content;
displaying on at least one said display screen one or more help topics with a corresponding said help content file wherein said textual help content corresponding to said one or more help topics being displayed contains one or more of said search keywords.

6. The method according to claim 5, wherein said one or more help content files contain detailed help information on the control and operation of the multi-function peripheral and on said command functions.

7. The method according to claim 5, wherein said one or more help content files are in XML file format.

8. The method according to claim 5, further comprising displaying a virtual keyboard prior to said receiving said one or more search keywords, wherein said receiving said one or more search keywords is received from said virtual keyboard by a user entering said one or more search keywords.
